(19) United States
(12) Patent Application Publication
(10) Pub. No.: US 2014/0153376 A1
(43) Pub. Date: Jun. 5, 2014

(54) OPTICAL PICKUP APPARATUS

(71) Applicant: Samsung Electronics Co., Ltd., Suwon-si (KR)

(72) Inventors: Myoung-seok KIM, Suwon-si (KR); Jae-hyun KIM, Suwon-si (KR); Sang-yeal PARK, Hwaseong-si (KR); Joji ANZAI, Suwon-si (KR); Kab-kyun JEONG, Hwaseong-si (KR); Shuichi TASAKA, Seongnam-si (KR)

(73) Assignee: Samsung Electronics Co., Ltd., Suwon-si (KR)

(21) Appl. No.: 14/075,511

(22) Filed: Nov. 8, 2013

(30) Foreign Application Priority Data
Dec. 5, 2012 (KR) 10-2012-0140598

(51) Int. Cl. G11B 7/1381

(52) U.S. Cl. CPC G11B 7/1381
USPC 369/112.05

(57) ABSTRACT

An optical pickup apparatus which includes a light transmitting system is provided. A light source system provides the light transmitting system with light; a light receiving system includes detectors which are configured to detect light reflected from the multilayer optical disk; and a stray light controller is configured to prevent stray light from reaching the detectors. The stray light controller is disposed between the light source system and the light receiving system. The stray light controller includes a light transmitting portion through which light reflected from the multilayer optical disk and the stray light are configured to pass; a light diffraction portion is configured to diffract the light reflected from the multilayer optical disk and the stray light; and a light blocking portion configured to block the light reflected from the multilayer optical disk and the stray light.

### CROSS-REFERENCE TO RELATED APPLICATIONS

This application claims the benefit under 35 U.S.C. §119(a) from Korean Patent Application No. 2012-0140598 filed Dec. 5, 2012 in the Korean Intellectual Property Office, the disclosure of which is incorporated herein by reference, in its entirety.

### BACKGROUND

1. Field

The present disclosure relates to an optical pickup apparatus. More particularly, the disclosure relates to an optical pickup apparatus that can be applied to multilayer optical disks.

2. Description of the Related Art

A light pickup apparatus refers to an apparatus that uses light to record information on an optical disk to play back information from the optical disk. The optical disks may be classified as a compact disk (CD), a digital versatile disk (DVD), a Blu-ray Disk™ (BD), etc. depending on the information recording capacity. Recently, there has been a huge increase in the storage capacity of disks. This has resulted in an increase in the usage of multilayer disks.

Generally, an optical pickup apparatus applied to the multilayer optical disk divides a light beam emitted from a light source into three light beams to provide tracking control of the multilayer optical disk. This is called a “three beams method.” The optical pickup apparatus obtains one main light beam and two sub light beams by using a diffraction element provided between the light source and a light splitter. The optical pickup apparatus includes a light receiving system that detects the main light beam and the two sub light beams reflected from the multilayer optical disk, and then converts them into electrical signals.

However, the optical pickup apparatus in the related art has a problem that light interference between a light beam reflected on a recording layer that a user wants to play back and light beams (hereinafter, referred to as stray light) reflected on recording layers other than the recording layer that the user wants to play back, occurs in the light receiving system. The light interference caused by the stray light acts as optical noise, thereby disturbing the tracking control of the multilayer optical disk or disturbing implementation of good playback signals.

For solving these problems optical pickup apparatuses of the related art control the stray light by arranging a stray light controller to control the stray light between an objective lens and a collimating lens of a light source system. However, in the optical pickup apparatuses of the related art, since the stray light controller is disposed in the light source system, both incident and reflected light beams pass through the stray light controller. Accordingly, the optical pickup apparatuses of the related art need a separate polarizing element to change polarization properties in order to separate the incident light beam and the reflected light beam, and the stray light controller also needs to have polarization properties. However, due to the polarizing element and the stray light controller with the polarization properties, the optical pickup apparatuses of the related art experience the problem that manufacturing costs thereof increase and manufacturing efficiency thereof is decreased.

### SUMMARY

The present disclosure has been developed in order to overcome the above drawbacks and other problems associated with the arrangements of the related art. An aspect of exemplary embodiments of the present disclosure is to provide an optical pickup apparatus that can reduce manufacturing costs in a light receiving system and prevent light interference from occurring.

The above aspect and/or other features of the exemplary embodiments can substantially be achieved by providing an optical pickup apparatus, which may include a light transmitting system comprising an objective lens which faces a multilayer optical disk with a plurality of recording layers; a light source system which provides the light transmitting system with a plurality of light beams; a light receiving system which comprises a plurality of detectors which detect the plurality of light beams reflected from the multilayer optical disk; and a stray light control which prevents stray light generated from the multilayer optical disk from reaching the plurality of detectors, wherein the stray light controller is disposed on a path of light travel between the light source system and the light receiving system; the stray light controller comprises a light transmitting portion through which the plurality of light beams reflected from the multilayer optical disk and the stray light generated from the multilayer optical disk will pass; a light diffraction portion is provided in the light transmitting portion, and diffracts the plurality of light beams reflected from the multilayer optical disk and the stray light generated from the multilayer optical disk; and a light blocking portion is provided in the light transmitting portion, and blocks the plurality of light beams reflected from the multilayer optical disk and the stray light generated from the multilayer optical disk, and the light diffraction portion extends along a direction of the light transmitting portion with a predetermined width.

The light diffraction portion may be provided on one surface of the light transmitting portion, and the light blocking portion may be provided on the other surface of the light transmitting portion which is opposite to the one surface of the light transmitting portion.

The light diffraction portion may include linear diffraction gratings.

The light blocking portion may be disposed in front of the light diffraction portion, and may have a width which is narrower than that of the light diffraction portion.

Each of the plurality of detectors may include a main detecting portion in which the plurality of light beams reflected from the multilayer optical disk and passed through the light transmitting portion are imaged; and may include at least one auxiliary detecting portion in which the plurality of light reflected from the multilayer optical disk and passed through the light diffraction portion is imaged.

The main detecting portion may include a main cell in which a main light beam of the plurality of light beams is imaged, the main cell may be formed as a four slit cell with sub cells disposed above and below the main cell, the sub cells in which sub light beams of the plurality of light beams are focused, the sub cell formed as a two slit cell.

The auxiliary detecting portion may include two auxiliary detecting portions, each of the two auxiliary detecting portions may be disposed above and below the main detecting portion, and the sub light beams of the plurality of light beams may be imaged in the two auxiliary detecting portions.

Some portion of a main light beam of the stray light generated from the multilayer optical disk may pass through the light transmitting portion of the stray light controller, and then may be imaged in left and right sides which spaced apart from the main detecting portion, and others of the main light beam of the stray light generated from the multilayer optical disk may pass through the light diffraction portion of the stray light controller, and then may be imaged in areas that are spaced apart both above and below from the main detecting portion and may surround the auxiliary detecting portions.

The light blocking portion may block the main light beam of the stray light to pass through the light diffraction portion from being imaged in the areas of the auxiliary detecting portions.

A sub light beam of the stray light generated from the multilayer optical disk may pass through the stray light controller, and may then be imaged similarly to the imaging form of the main light beam of the stray light.

The light transmitting portion may include a glass plate having a predetermined thickness.

The light blocking portion may be formed by chrome coating.

The light source system may include at least one light source; a diffraction element which diffracts light generated from the light source to form a main light beam, a first sub light beam, and a second sub light beam; and a light splitter which reflects the main light beam, the first sub light beam, and the second sub light beam toward the light transmitting system or to guide the main light beam, the first sub light beam, and the second sub light beam reflected from the multilayer optical disk, toward the light receiving system.

The light receiving system may include a light detector comprising the plurality of detectors; and a sensor lens disposed on a light travel path between the light detector and the light splitter.

The stray light controller may be disposed on a light travel path between the sensor lens and the light splitter.

The light transmitting system may include a collimating lens that is disposed on a light travel path between the objective lens and the light source and may convert the plurality of light beams into parallel light beams.

The at least one light source may include at least one of a Blu-ray Disk™ light source, a DVD light source, and a CD light source.

The at least one light source may be the Blu-ray Disk® light source.

With various exemplary embodiments of the present disclosure, an optical pickup apparatus that reduces manufacturing costs thereof and prevents interference light from being generated in a light receiving system, can be implemented.

Exemplary embodiments may provide an optical pickup apparatus including: a light transmitting system including an objective lens which faces a multilayer optical disk having a plurality of recording layers; a stray light controller which prevents stray light generated from the multilayer optical disk from reaching a plurality of detectors, the stray light controller includes a light transmitting portion through which a plurality of light beams reflected from the multilayer optical disk and the stray light generated from the multilayer optical disk pass; a light diffraction portion which diffracts the plurality of light beams reflected from the multilayer optical disk and the stray light generated from the multilayer optical disk; and a light blocking portion which blocks the plurality of light beams reflected from the multilayer optical disk and the stray light generated from the multilayer optical disk.

In another exemplary embodiment, the stray light controller may include: a light transmitting portion through which a plurality of light beams reflected from a multilayer optical disk and stray light generated from multilayer optical disk pass; a light diffraction portion which diffracts the plurality of light beams reflected from the multilayer optical disk and the stray light generated from the multilayer optical disk; and a light blocking portion which blocks the plurality of light beams reflected from the multilayer optical disk and the stray light generated from the multilayer optical disk.

Other objects, advantages and salient features of the present disclosure will become apparent from the following detailed description, which, taken in conjunction with the annexed drawings, discloses preferred exemplary embodiments.

### BRIEF DESCRIPTION OF THE DRAWINGS

These and/or other aspects and advantages of the disclosure will become apparent and more readily appreciated from the following description of the exemplary embodiments, taken in conjunction with the accompanying drawings of which:

FIG. 1 is a view which schematically illustrates a configuration of an optical pickup apparatus, according to an exemplary embodiment;

FIG. 2 is a perspective view which schematically illustrates a stray light controller provided in the optical pickup apparatus of FIG. 1;

FIG. 3 is a plan view which schematically illustrates a stray light controller provided in the optical pickup apparatus of FIG. 1;

FIG. 4 is a sectional view which schematically illustrates a stray light controller provided in the optical pickup apparatus of FIG. 1;

FIG. 5 is a view which schematically illustrates a configuration of a light detector provided in a light receiving system of the optical pickup apparatus of FIG. 1;

FIG. 6 is a view which schematically illustrates a reflected light beam of a playback layer of a multilayer optical disk that is passing through the stray light controller of FIG. 2;

FIG. 7 is a view which schematically illustrates a state in which the reflected light beam of the playback layer of the multilayer optical disk passed through the stray light controller of FIG. 6 is imaged on a light detector;

FIG. 8 is a view which schematically illustrates stray light of a multilayer optical disk that is passing through the stray light controller of FIG. 2;

FIG. 9 is a view which schematically illustrates a state in which the stray light of the multilayer optical disk passed through the stray light controller of FIG. 8 is imaged on a light detector;

FIG. 10 is a view which schematically illustrates a state in which both a reflected light beam of a playback layer of a multilayer optical disk and stray light of a multilayer optical disk are imaged on a light detector; and

FIG. 11 is a view which schematically illustrates a configuration of an optical pickup apparatus according to another exemplary embodiment.

Throughout the drawings, like reference numerals will be understood to refer to like parts, components and structures.

### DETAILED DESCRIPTION OF THE EXEMPLARY EMBODIMENTS

Hereinafter, certain exemplary embodiments will be described in detail with reference to the accompanying drawings.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

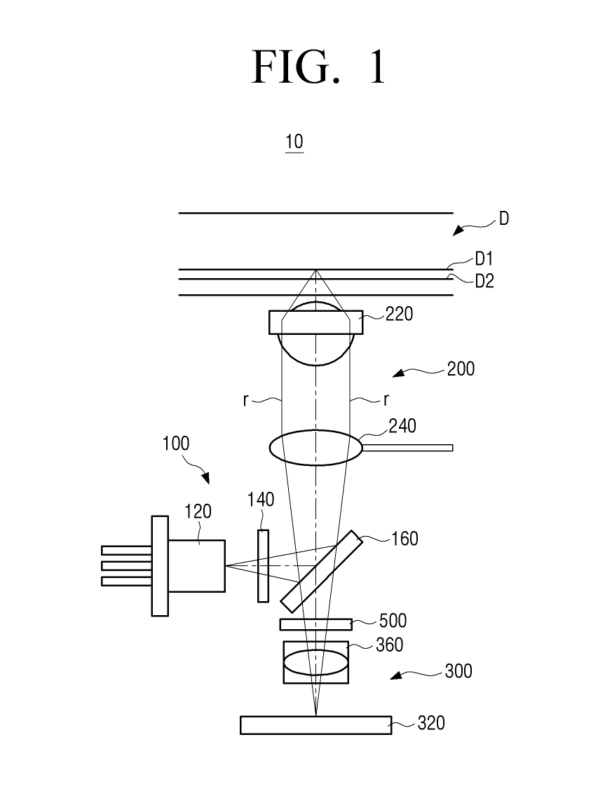

FIG. 1 is a view which schematically illustrates a configuration of an optical pickup apparatus according to an exemplary embodiment.

An optical pickup apparatus for Blu-ray Disks® (BDs) will be illustrated as an optical pickup apparatus according to an exemplary embodiment; however, a following description with respect to the an exemplary embodiment of the present disclosure may be equally applied to optical pickup apparatuses for compact disks (CDs) and optical pickup apparatuses for digital versatile disks (DVDs).

Referring to FIG. 1, an optical pickup apparatus 10 includes a light source system 100, a light transmitting system 200, a light receiving system 300, and a stray light controller 500.

The light source system 100 includes a light source 120, a diffraction element 140, and a light splitter 160.

The light source 120 generates a light beam which is used to record information on a multilayer optical disk D which is implemented as a Blu-ray Disk® (BD), and to playback information recorded on the multilayer optical disk D. The light source 120 may include a laser diode to generate the light beam. However, the light source 120 is not limited thereto, but may include different light generating devices.

The diffraction element 140 forms a single light beam from the light source 120 into 0 order main light beam and ±1 order sub light beams by a diffraction effect. In other words, the diffraction element 140 diffracts the single light beam into three light beams. The diffraction element 140 may change intervals between the main light beam and the sub light beams, depending on interval or period of grating thereof.

The light splitter 160 reflects the main light beam and the ±1 order sub light beams toward the light transmitting system 200, and allows a reflected light beam reflected from the multilayer optical disk D to pass there through toward the light receiving system 300.

The light transmitting system 200 includes an objective lens 220 and a collimating lens 240.

The objective lens 220 is disposed to face the multilayer optical disk D, and focuses the main light beam and ±1 order sub light beams on the multilayer optical disk D.

The collimating lens 240 is disposed on a light travel path r between the objective lens 220 and the light splitter 160. The collimating lens 240 converts the 0 order main light beam and ±1 order sub light beams into parallel light beams. The 0 order main light beam and ±1 order sub light beams are converted into parallel light beams by the collimating lens 240 before being incident on the objective lens 220.

The light receiving system 300 includes a light detector 320 and a sensor lens 360.

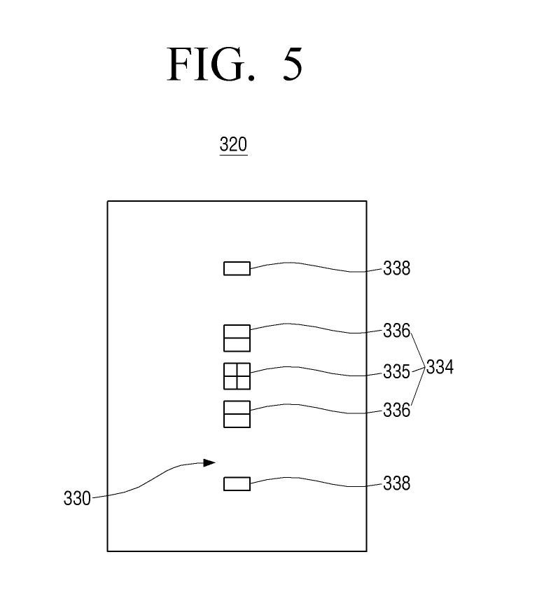

The light detector 320 detects the 0 order main light beam and ±1 order sub light beams which are reflected on the multilayer optical disk D through a detector 330 (see FIG. 5), and then converts the light beams into electrical signals. Information recorded on the multilayer optical disk D may be played back by the electrical signals, and control signals for driving the optical pickup apparatus 10 may be obtained from the electrical signals.

The sensor lens 360 is a concave lens, and is disposed on the light travel pass r between the light detector 320 and the light splitter 160. The sensor lens 360 converts the 0 order main light beam and ±1 order sub light beams reflected from the multilayer optical disk D into a form that the light detector 320 can detect.

The stray light controller 500 prevents stray light generated in the multilayer optical disk D from reaching the detector 330 (see FIG. 5) of the light detector 320. The stray light does not refer to a reflected light beam (here, the reflected light beam includes both the 0 order main light beam and ±1 order sub light beam) coming from a recording layer D1 which is desired to be played back from the multilayer optical disk D but rather is a reflected light beam (the stray light also includes the 0 order main light beam and ±1 order sub light beam) coming from a recording layer D2 other than the recording layer D1 desired to be played back. When the stray light reaches the detector 330 (see FIG. 5) of the light detector 320, the stray light interferes with the reflected light beam coming from the recording layer D1 desired to be played back, and thus acts as optical noise, thereby disturbing the tracking control of the multilayer optical disk D the or implementation of good playback signals. The stray light controller 500 controls the stray light, and thus prevents the stray light from reaching the detector 330 (see FIG. 5) of the light detector 320.

The stray light controller 500 is disposed on the light travel pass r between the light source system 100 and the light receiving system 300. In particular, the stray light controller 500 is disposed on the light travel pass r between the light splitter 160 and the sensor lens 360. In the optical pickup apparatus 10, according to an exemplary embodiment, due to the above-described arrangement, only the reflected light beam from the multilayer optical disk D passes through the stray light controller 500. In other words, in the optical pickup apparatus 10, according to an exemplary embodiment, the incident light beam of the multilayer optical disk D generated in the light source 120 does not pass through the stray light controller 500.

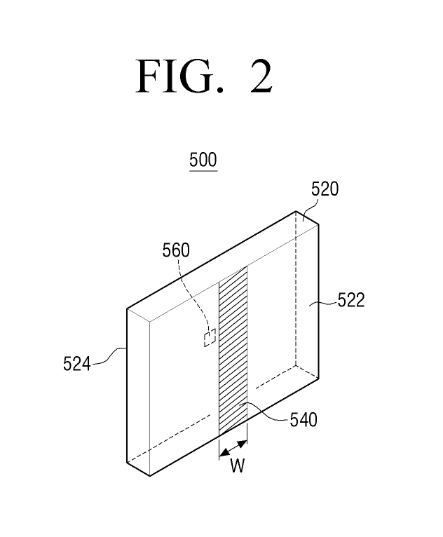

Accordingly, the optical pickup apparatus 10 according to an exemplary embodiment does not require a separate diffraction element to separate the incident light beam and the reflected light beam, and the stray light controller 500 also does not require the polarization properties of the related art. Accordingly, since the optical pickup apparatus 10 according to an exemplary embodiment does not require a separate diffraction element, the manufacturing costs caused by the diffraction element may be reduced, and since the stray light controller 500 also does not need to have the polarization properties, manufacturing efficiency of the stray light controller 500 may become excellent. The stray light controller 500 will be described in detail hereinafter with reference to FIGS. 2, 3 and 4.

Eventually, since the optical pickup apparatus 10 according to an exemplary embodiment has a stray light controller 500 that can be manufactured at low cost, the manufacturing costs of the optical pickup apparatus 10, may be reduced.

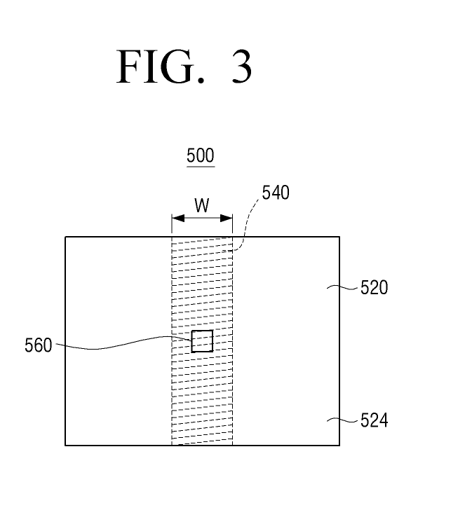

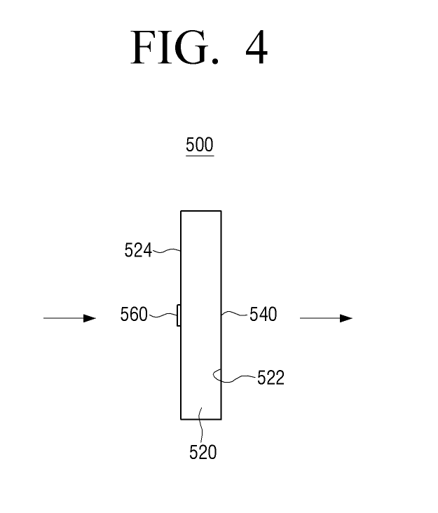

FIG. 2 is a perspective view which schematically illustrates a stray light controller provided in the optical pickup apparatus of FIG. 1, FIG. 3 is a plan view which schematically illustrates the stray light controller provided in the optical pickup apparatus of FIG. 1, and FIG. 4 is a sectional view which schematically illustrates the stray light controller provided in the optical pickup apparatus of FIG. 1.

Referring to FIGS. 2, 3, and 4, the stray light controller 500 includes a light transmitting portion 520, a light diffraction portion 540, and a light blocking portion 560.

The light transmitting portion 520 allow the reflected light beam to pass there through, and is formed as a rectangular plate shape with a predetermined thickness. The reflected light beam includes the stray light. The light transmitting portion 520 may be formed of glass materials through which the reflected light beam can pass. However, the material of the light transmitting portion 520 is not limited thereto. The light transmitting portion 520 may be formed of different types of materials as long as the reflected light beam can pass through.

The light transmitting portion 520 is disposed so that a front surface 524 thereof faces the light splitter 160 and a rear surface 522 thereof faces the sensor lens 360. Therefore, the reflected light beam which passes through the light transmitting portion 520 travels from the front surface 524 of the light transmitting portion 520 to the rear surface 522 thereof along a direction of the arrows of FIG. 4.

The light diffraction portion 540 functions to diffract the reflected light beam, and is provided on the rear surface 522 of the light transmitting portion 520. The reflected light beam includes stray light. The light transmitting portion 520 is formed to extend with a predetermined width W in a longitudinal direction of the light transmitting portion 520. The light diffraction portion 540 consists of linear diffraction gratings which are obliquely formed, and is formed through a mask process on the rear surface 522 of the light transmitting portion 520.

The light blocking portion 560 blocks the reflected light beam, and is provided on the front surface 524 of the light transmitting portion 520. The reflected light beam includes the stray light. The light blocking portion 560 is formed in a rectangular shape, is disposed in front of the light diffraction portion 540, and has a width narrower than that of the light diffraction portion 540. The light blocking portion 560 is formed through chrome coating on the front surface 524 of the light transmitting portion 520.

Since only the reflected light beam can pass through the stray light controller 500 according to an exemplary embodiment as described above, the stray light controller 500 does not require the polarization properties for separation of the incident light beam. Accordingly, the stray light controller 500 can control the stray light by forming the light diffraction portion 540 and the light blocking portion 560 on the light transmitting portion 520 through simple processes.

FIG. 5 is a view which schematically illustrates a configuration of a light detector provided in a light receiving system of the optical pickup apparatus of FIG. 1.

Referring to FIG. 5, the light detector 320 includes a detector 330.

The detector 330 includes a main detecting portion 334 and auxiliary detecting portions 338.

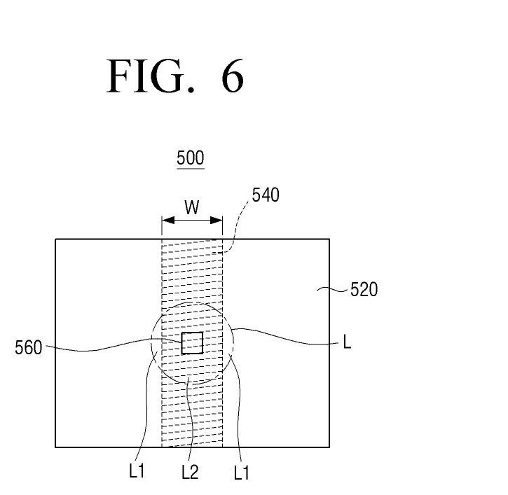

The main detecting portion 334 includes a main cell 335 and sub cells 336. The main detecting portion 334 detects a reflected light beam L1 (see FIG. 6) that passes through the light transmitting portion 520 of the stray light controller 500 from among the reflected light beam L (see FIG. 6) coming out from the recording layer D1 desired to be played back.

The main cell 335 images the 0 order main light beam of the reflected light beam L1 (see FIG. 6) coming out from the recording layer D1 (see FIG. 1) for playback. The main cell 335 consists of four split cell. The main cell 335 may consist of two split cell other than the four split cell. The cell split of the main cell 335 may be changed depending on the design.

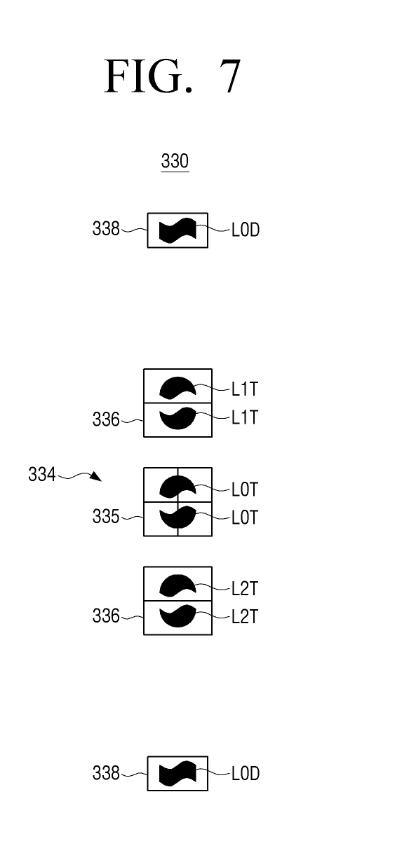

The sub cells 336 images the ±1 order sub light beams L1T and L2T (see FIG. 7) among the reflected light beam L1 (see FIG. 6) coming out from the recording layer D1 (see FIG. 1) to be played back. Two sub cells 336 are provided, and disposed above and below the main cell 335, respectively. A sub cell 336 disposed above the main cell 335 images +1 order sub light beam L1T (see FIG. 7), and a sub cell 337 disposed below the main cell 335 images −1 order sub light beam L2T (see FIG. 7).

Each of the sub cells 336 consists of a two split cell. Each of the sub cells 336 may consist of a four split cell other than the two split cell. The cell split of each of the sub cells 336 may be changed depending on the design.

The auxiliary detecting portions 338 detects a reflected light beam L2 (see FIG. 6) that passes through the light diffraction portion 540 of the stray light controller 500 from among the reflected light beam L (see FIG. 6) coming out from the recording layer D1 (see FIG. 1) to be played back. Two auxiliary detecting portions 338 are provided. Each of the auxiliary detecting portions 338 is disposed above and below the main detecting portion 334. In particular, each of the auxiliary detecting portions 338 is disposed above and below the sub cells 336, and is spaced apart from each of the sub cells 336. A spacing distance between each of the auxiliary detecting portions 338 and each of the sub cells 336 is designed so that the reflected light beam L2 (see FIG. 6) that passes through the light diffraction portion 540 of the stray light controller 500 from among the reflected light beam L (see FIG. 6) coming out from the recording layer D1 (see FIG. 1) to be played back, can be imaged within the auxiliary detecting portion 338.

Each of the auxiliary detecting portions 338 consists of a single cell. However, this is only one example. Therefore, each of the auxiliary detecting portions 338 may consist of a split cell instead of a single cell, depending on the design thereof.

Each of the auxiliary detecting portions 338 disposed above and below the main detecting portion 334 detects 0 order diffracted main light beam L0D (see FIG. 6) from among the reflected light beam L2 (see FIG. 6) coming out from the recording layer D1 (see FIG. 1) to be played back. This will be described in detail hereinafter with reference to FIG. 7.

FIG. 6 is a view which schematically illustrates a reflected light beam of a playback layer of a multilayer optical disk that is passing through the stray light controller of FIG. 2, and FIG. 7 is a view which schematically illustrates a state in which the reflected light beam of the playback layer of the multilayer optical disk passed through the stray light controller of FIG. 6 is imaged on a light detector.

Referring to FIG. 6, the reflected light beam L coming out from the recording layer D1 (see FIG. 1) to be played back, passes through the objective lens 220 (see FIG. 1), the collimating lens 240 (see FIG. 1), and the light splitter 160 (see FIG. 1), and then passes through the stray light controller 500.

The reflected light beam L coming out from the recording layer D1 (see FIG. 1) to be played back has a width slightly wider than the width W of the light diffraction portion 540 of the stray light control unit 500. The reflected light beam L coming out from the recording layer D1 (see FIG. 1) to be played back may be divided into a reflected light beam L1 that passes through the light transmitting portion 520 of the stray light controller 500 and a reflected light beam L2 that passes through the light diffraction portion 540 of the stray light controller 500. The reflected light beam L1 that passes through the light transmitting portion 520 of the stray light controller 500 is formed on each of the left and right sides of the reflected light beam L2 that passes through the light diffraction portion 540 of the stray light controller 500.

Referring to FIG. 7, the reflected light beam L (see FIG. 6) coming out from the recording layer D1 (see FIG. 1) to be played back that passes through the stray light control unit 500 is imaged in each of the plurality of detectors 330. A detailed description thereof will follow.

First, in response to looking at the reflected light beam L1 that passes through the light transmitting portion 520, the 0 order main light beam L0T of the reflected light beam L1 that passes through the light transmitting portion 520 is imaged in the main cell 335 of the main detecting portion 334. The 0 order main light beam L0T is imaged in the form of two half-moons with a cut central portion. This results from exclusion of the area of the reflected light beam L2 that passes through the light diffraction portion 540.

Then, the 0 order main light beam L0T is formed in the form of half-moon up and down. This results from the phase of the reflected light beam L which changes 90 degrees while the reflected light beam L passes through the sensor lens 360. When the reflected light beam L coming out from the recording layer D1 (see FIG. 1) to be played back passes through the sensor lens 360, the phase thereof changes 90 degrees. This is well known; therefore a detailed description thereof will be omitted.

The +1 order sub light beam L1T of the reflected light beam L1 that passes through the light transmitting portion 520 is imaged in the sub cell 336 which is disposed above the main cell 335 of the main detecting portion 334. The +1 order sub light beam L1T also is imaged in the form of two half-moons like the 0 order main light beam L0T. The reason that the +1 order sub light beam L1T is imaged like that is the same as that of the 0 order main light beam L0T, as described above.

The −1 order sub light beam L2T of the reflected light beam L1 that passes through the light transmitting portion 520 is imaged in the sub cell 336 which is disposed below the main cell 335 of the main detecting portion 334. The −1 order sub light beam L2T also is imaged in the form of two half-moons like the 0 order main light beam L0T and the +1 order sub light beam L1T. The reason that the −1 order sub light beam L2T is imaged like that is the same as those of the 0 order main light beam L0T and the +1 order sub light beam L1T as described above.

Next, the reflected light beam L2 that passes through the light diffraction portion 540 will be described hereinafter.

The 0 order main light beam of the reflected light beam L2 is diffracted while passing through the light diffraction portion 540, and thus forms three light beams of second 0 order main light beam (not illustrated), and second ±1 order sub light beams L0D. Here, since the second 0 order main light beam (not illustrated) has low optical efficiency, it is not imaged in the detector 330. Then, the second ±1 order sub light beam L0D is imaged in each of the auxiliary detecting portions 338.

The second ±1 order sub light beams L0D have a shape which corresponds to the cut central portion of the 0 order main light beam L0T. The phase of the second ±1 order sub light beam L0D changes 90 degrees while it passes through the sensor lens 360 like the 0 order main light beam L0T, and thus it is imaged in the auxiliary detecting portions 338.

The ±1 order sub light beams (not illustrated) of the reflected light beam L2 is not imaged in the plurality of detectors 330. In particular, each ±1 order sub light beam (not illustrated) of the reflected light beam L2 is diffracted while passing through the light diffraction portion 540, and thus forms three light beams (0 order main light beam and ±1 order sub light beams) like the 0 order main light beam of the above-described reflected light beam L2. Here, the 0 order main light beam (not illustrated) that passes through the light diffraction portion 540 is not imaged in the detector 330 due to low optical efficiency, and each of the ±1 order sub light beams (not illustrated) that passes through the light diffraction portion 540 is imaged in areas other than the main detecting portion 334 and the auxiliary detecting portions 338. As a result, the ±1 order sub light beams (not illustrated) of the reflected light beam L2 are not imaged within the plurality of detectors 330.

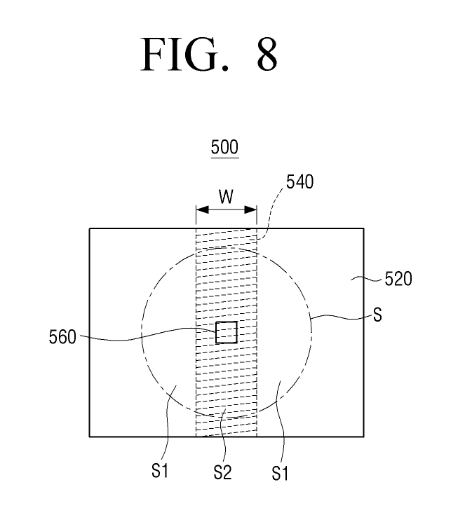

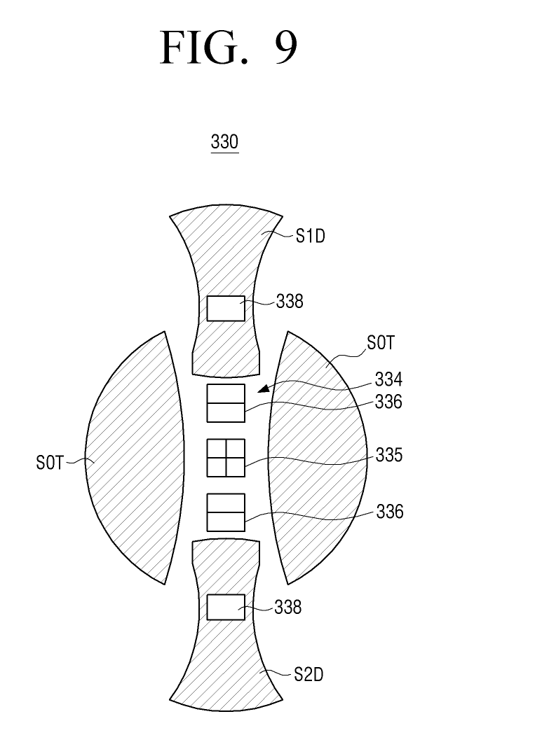

FIG. 8 is a view which schematically illustrates stray light of a multilayer optical disk that is passing through the stray light controller 500 of FIG. 2 FIG. 9 is a view which schematically illustrates a state in which the stray light of the multilayer optical disk passed through the stray light controller of FIG. 8 is imaged on a light detector.

Referring to FIG. 8, the stray light 0 (reflected light beams come out from recording layer D2 (see FIG. 1) other than the recording layer D1 (see FIG. 1) to be played back) passes through the objective lens 220 (see FIG. 1), the collimating lens 240 (see FIG. 1), and the light splitter 160 (see FIG. 1), and then passes through the stray light controller 500.

The stray light 0 has a wider width than that of the reflected light beam L coming out from the recording layer D1 (see FIG. 1) to be played back, as illustrated in FIG. 6. On the other hand, the stray light S may also be divided into a stray light beam S1 that passes through the light transmitting portion 520 of the stray light controller 500 and a stray light beam S2 that passes through the light diffraction portion 540 of the stray light controller 500.

The stray light beam S1 that passes through the light transmitting portion 520 of the stray light controller 500 is arranged on the left and right sides of the stray light beam S2 that passes through the light diffraction portion 540 of the stray light controller 500.

Referring to FIG. 9, the stray light S (see FIG. 6) that passes through the stray light controller 500 is not imaged within the plurality of detecting units 330. Detailed description thereof will be described hereinafter.

In response to looking at the stray light beam S1 that passes through the light transmitting portion 520, 0 order main light beam SOT of the stray light beam S1 that passes through the light transmitting portion 520 is imaged in positions spaced outward from the left and right sides of the main detecting portion 334 of the detector 330. The 0 order main light beam S0T is imaged in the form of two half-moons with a cut central portion. This results from that the stray light beam S2 that passes through the light diffraction portion 540 being excluded.

Then, the 0 order main light beam SOT is formed in the form of half-moon on the left and right. This is because the stray light S has an incident angle which is different compared to the reflected light beam L of FIG. 6, so that the phase of the stray light S does not change even after the stray light S passed through the sensor lens 360.

On the other hand, ±1 order sub light beam (not illustrated) of the stray light beam S1 that passes through the light transmitting portion 520 is imaged in the almost the same position as and in a form similar to those of the 0 order main light beam SOT. In detail, the +1 order sub light beam (not illustrated) is placed slightly above the 0 order main light beam SOT, and the −1 order sub light beam (not illustrated) is placed slightly below the 0 order main light beam SOT.

Next, the stray light beam S2 that passes through the light diffraction portion 540 will be described hereinafter.

The 0 order main light beam of the stray light beam S2 is diffracted while passing through the light diffraction portion 540, and thus forms three light beams of second 0 order main light beam (not illustrated), and second ±1 order sub light beams S1D and S2D. Since the second 0 order main light beam (not illustrated) has low optical efficiency, it is not imaged in the detector 330.

Then, the second +1 order sub light beam S1D is imaged in an area surrounding the auxiliary detecting portions 338 above the main detecting portion 334, and the second −1 order sub light beam S2D is imaged in an area surrounding the auxiliary detecting portions 338 below the main detecting portion 334.

On the other hand, when the 0 order main light beam of the stray light beam S2 passes through the light diffraction portion 540, a portion of the 0 order main light beam which corresponds to the light blocking portion 560 is blocked. Accordingly, the second +1 order sub light beam S1D and the second −1 order sub light beam S2D are not imaged within the auxiliary detecting portions 338.

Each of the ±1 order sub light beams of the stray light beam S2 is diffracted while passing through the light diffraction portion 540, and thus forms three light beams (0 order main light beam and ±1 order sub light beams) like the 0 order main light beam of the above-described stray light S2. The 0 order main light beam (not illustrated) that passes through the light diffraction portion 540 is not imaged in the detectors 330 due to low optical efficiency.

Each of the +1 order sub light beam (not illustrated) that passes through the light diffraction portion 540 is imaged in the almost the same position as and in the form similar to those of the second +1 order sub light beam S1D. Each of the +1 order sub light beam (not illustrated) is placed slightly above the second +1 order sub light beam S1D.

Each of the −1 order sub light beam (not illustrated) that passes through the light diffraction portion 540 is imaged in the almost the same position as and in the form similar to those of the second −1 order sub light beam S2D. Each of the −1 order sub light beam (not illustrated) is placed slightly below the second −1 order sub light beam S2D.

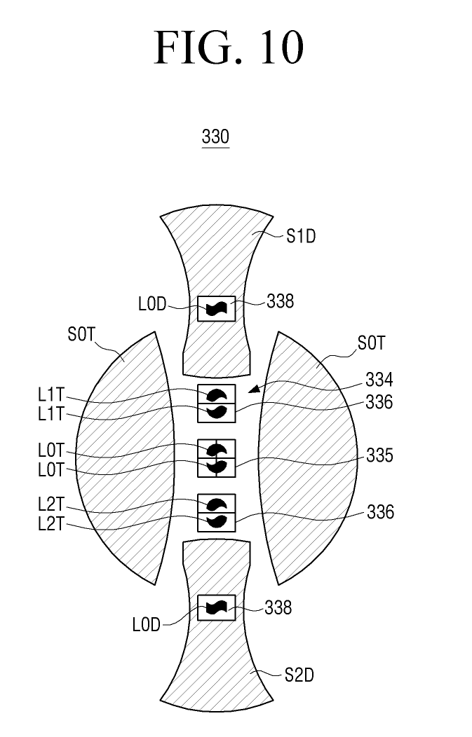

FIG. 10 is a view which schematically illustrates a state in which both a reflected light beam of a playback layer of a multilayer optical disk and stray light of a multilayer optical disk are imaged on a light detector.

Referring to FIG. 10, the 0 order main light beam L0T, +1 order sub light beam L1T, −1 order sub light beam L2T, and 0 order diffracted main light beam L0D of the reflected light beam L (see FIG. 6) are imaged within the plurality of detectors 330. The 0 order main light beam SOT, and the second +1 order sub light beam S1D and second −1 order sub light beam S2D of the 0 order diffracted main light of the stray light S (see FIG. 8) are imaged in areas outside of the plurality of detectors 330.

In other words, the reflected light beam L (see FIG. 6) and the stray light S (see FIG. 8) do not overlap with each other within the light detector 320 (see FIG. 5), and thus interference light is not generated. Accordingly, since the interference light is not generated in the light detector 320 (see FIG. 5), the optical pickup apparatus 10 (see FIG. 1) according to an exemplary embodiment can perform a smooth tracking control of the multilayer optical disk and can achieve good playback signals.

On the other hand, the +1 order sub light beam L1T and −1 order sub light beam L2T are used to generate servo signals. The 0 order main light beam L0T is used to generate RF signals. Here, the RF signals may be reduced compared to the signals of the related art according as the 0 order main light L0T is imaged in a form that the central portion of the 0 order main light beam L0T is cut off. However, since the optical pickup apparatus 10 (see FIG. 1) according to an exemplary embodiment is formed so that the 0 order diffracted main light L0D which corresponds to the form of 0 order main light beam L0T with the cut central portion is imaged within the auxiliary detecting portions 338, RF signals with the same size or signal quality as that of the signals of the related art may be generated.

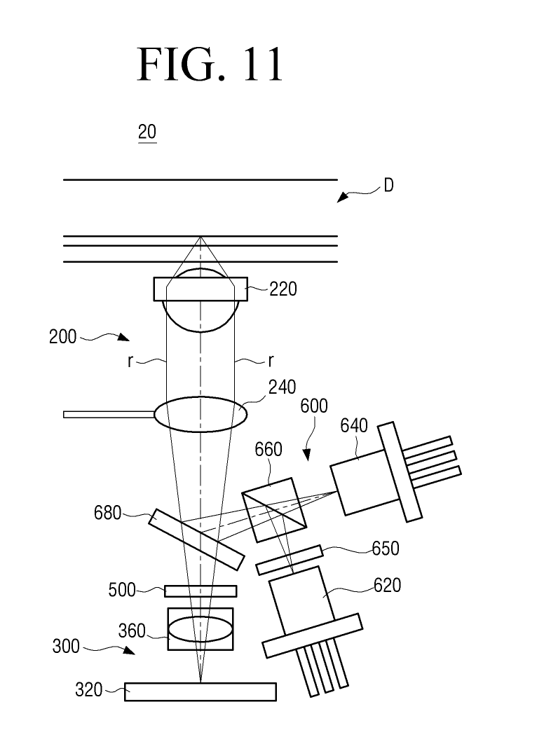

FIG. 11 is a view which schematically illustrates a configuration of an optical pickup apparatus according to another exemplary embodiment.

Referring to FIG. 11, the optical pickup apparatus 20 includes a light transmitting system 200, a light receiving system 300, a stray light controller 500, and a light source system 600.

The optical pickup apparatus 10 according to an exemplary embodiment as described above, may be applied to one of CD, DVD, and BD. However, the optical pickup apparatus 20 according to the exemplary embodiment is a compatible optical pickup apparatus that can be compatible with all CD, DVD, and BD. Accordingly, the optical pickup apparatus 20 according to the exemplary embodiment is provided with a CD light source, a DVD light source, and a BD light source.

The light transmitting system 200, the light receiving system 300, and the stray light controller 500 are substantially the same as the configuration of the previous exemplary embodiment; therefore, duplicate descriptions thereof will be omitted.

The light source system 600 includes a first light source 620, a second light source 640, a diffraction element 650, a first light splitter 660, and a second light splitter 680.

The first light source 620 includes a CD light source and a DVD light source. For example, the CD light source may be a laser diode to generate light of 780 nm, and the DVD light source may be a laser diode to generate light of 650 nm.

The second light source 640 includes a BD light source. For example, the BD light source may be a laser diode to generate light of 405 nm.

The diffraction element 650 is substantially the same as the diffraction element 140 of the previous exemplary embodiment. Therefore, duplicate description thereof will be omitted.

The first light splitter 660 allows light generated from the second light source 640 to pass therethrough toward the second light splitter 680, and reflects light generated from the first light source 620 toward the second light splitter 680.

The second light splitter 680 is substantially the same as the light splitter 160 of the previous exemplary embodiment. Therefore, duplicate description thereof will be omitted.

Since the optical pickup apparatus 20 according to the present exemplary embodiment also is provided with the stray light controller 500 disposed on the light travel path r between the light source system 600 and the light receiving system 300, like the above-described optical pickup apparatus 10, the polarization properties for separation of an incident light beam and a reflected light beam are not required. Accordingly, since the optical pickup apparatus 20 according to the exemplary embodiment may be provided with the stray light controller 500 at a low manufacturing cost The manufacturing costs of the optical pickup apparatus 20 may be reduced, and generation of interference light caused by the stray light may be prevented.

While the exemplary embodiments have been described, additional variations and modifications of the exemplary embodiments would be clear to those skilled in the art. Therefore, it is intended that the appended claims shall be construed to include both the above exemplary embodiments and all such variations and modifications that fall within the spirit and scope of the disclosure.

What is claimed is:

1. An optical pickup apparatus comprising:
a light transmitting system including an objective lens configured to face a multilayer optical disk having a plurality of recording layers;
a light source system configured to provide the light transmitting system with a plurality of light beams;
a light receiving system including a plurality of detectors configured to detect the plurality of light beams reflected from the multilayer optical disk; and
a stray light controller configured to prevent stray light generated from the multilayer optical disk from reaching the plurality of detectors,
wherein the stray light controller is disposed on a path of light travel between the light source system and the light receiving system,
the stray light controller comprises:
a light transmitting portion through which the plurality of light beams reflected from the multilayer optical disk and the stray light generated from the multilayer optical disk are configured to pass;
a light diffraction portion that is provided in the light transmitting portion, and diffracts the plurality of light beams reflected from the multilayer optical disk and the stray light generated from the multilayer optical disk; and
a light blocking portion that is provided in the light transmitting portion, and is configured to block the plurality of light beams reflected from the multilayer optical disk and the stray light generated from the multilayer optical disk, and
the light diffraction portion is configured to extend a predetermined width along a direction of the light transmitting portion.

2. The optical pickup apparatus of claim 1, wherein
the light diffraction portion is provided on one surface of the light transmitting portion, and the light blocking portion is provided on another surface of the light transmitting portion which is opposite to the one surface of the light transmitting portion.

3. The optical pickup apparatus of claim 2, wherein
the light diffraction portion comprises linear diffraction gratings.

4. The optical pickup apparatus of claim 2, wherein
the light blocking portion is disposed in front of the light diffraction portion, and has a narrower width than that of the light diffraction portion.

5. The optical pickup apparatus of claim 2, wherein
each of the plurality of detectors comprises
a main detecting portion in which the plurality of light beams reflected from the multilayer optical disk and passed through the light transmitting portion are imaged; and
at least one auxiliary detecting portion in which the plurality of light reflected from the multilayer optical disk and passed through the light diffraction portion are imaged.

6. The optical pickup apparatus of claim 5, wherein
the main detecting portion comprises:
a main cell in which a main light beam of the plurality of light beams is imaged, the main cell being formed as a four slit cell, and
sub cells are disposed above and below the main cell, the sub cells in which sub light beams of the plurality of light beams are focused, are formed as a two slit cell.

7. The optical pickup apparatus of claim 5, wherein
the auxiliary detecting portion comprises two auxiliary detecting portions, the two auxiliary detecting portions configured to be disposed above and below the main detecting portion, and the sub light beams of the plurality of light beams are imaged in the two auxiliary detecting portions.

8. The optical pickup apparatus of claim 5, wherein
some portion of a main light beam of the stray light generated from the multilayer optical disk passes through the light transmitting portion of the stray light controller, and then is imaged in left and right sides which are spaced apart from the main detecting portion, and
other portions of the main light beam of the stray light generated from the multilayer optical disk are configured to pass through the light diffraction portion of the stray light controller, and are then imaged in areas that are spaced apart from and above and below the main detecting portion and surround the auxiliary detecting portions.

9. The optical pickup apparatus of claim 8, wherein
the light blocking portion is configured to block the main light beam of the stray light passing through the light diffraction portion from being imaged in the areas of the auxiliary detecting portions.

10. The optical pickup apparatus of claim 8, wherein
a sub light beam of the stray light generated from the multilayer optical disk is configured to pass through the stray light controller, and is then imaged to the imaging form of the main light beam of the stray light.

11. The optical pickup apparatus of claim 1, wherein
the light transmitting portion comprises a glass plate configured to have a predetermined thickness.

12. The optical pickup apparatus of claim 1, wherein
the light blocking portion is formed by chrome coating.

13. The optical pickup apparatus of claim 1, wherein
the light source system comprises:
at least one light source;
a diffraction element configured to diffract light generated from the light source to form a main light beam, a first sub light beam, and a second sub light beam; and
a light splitter configured to reflect the main light beam, the first sub light beam, and the second sub light beam toward the light transmitting system or guides the main light beam, the first sub light beam, and the second sub light beam reflected from the multilayer optical disk toward the light receiving system.

14. The optical pickup apparatus of claim 13, wherein
the light receiving system comprises:
a light detector which is configured to include the plurality of detectors; and
a sensor lens configured to be disposed on a light travel path between the light detector and the light splitter.

15. The optical pickup apparatus of claim 14, wherein
the stray light controller is configured to be disposed on a light travel path between the sensor lens and the light splitter.

16. The optical pickup apparatus of claim 1, wherein
the light transmitting system further comprises a collimating lens that is configured to be disposed on a light travel path between the objective lens and the light source and is configured to convert the plurality of light beams into parallel light beams.

17. The optical pickup apparatus of claim 13, wherein
the at least one light source comprises at least one of a BD light source, a DVD light source and a CD light source.

18. The optical pickup apparatus of claim 17, wherein
the at least one light source is the BD light source.

19. An optical pickup apparatus comprising:
a light transmitting system including an objective lens which is configured to face a multilayer optical disk having a plurality of recording layers;
a stray light controller configured to prevent stray light generated from the multilayer optical disk from reaching a plurality of detectors,
the stray light controller is configured to include a light transmitting portion through which a plurality of light beams reflected from the multilayer optical disk and the stray light generated from the multilayer optical disk pass; a light diffraction portion configured to diffract the plurality of light beams reflected from the multilayer optical disk and the stray light generated from the multilayer optical disk; and a light blocking portion configured to block the plurality of light beams reflected from the multilayer optical disk and the stray light generated from the multilayer optical disk.

20. A stray light controller disposed between a light source system and a light receiving system, the stray light controller comprising:
a light transmitting portion through which a plurality of light beams reflected from a multilayer optical disk and stray light generated from multilayer optical disk are configured to pass;
a light diffraction portion configured to diffract the plurality of light beams reflected from the multilayer optical disk and the stray light generated from the multilayer optical disk; and
a light blocking portion configured to block the plurality of light beams reflected from the multilayer optical disk and the stray light generated from the multilayer optical disk.
